(19) United States
(12) Patent Application Publication
(10) Pub. No.: US 2019/0162424 A1
(43) Pub. Date: May 30, 2019

(54) HOT WATER USING SYSTEM AND RELAY DEVICE USED THEREIN

(71) Applicant: NORITZ CORPORATION, HYOGO (JP)

(72) Inventors: Kento Maruo, Kato-shi (JP); Masaru Ono, Kobe-shi (JP); Tsuyoshi Yamashita, Kako-gun Harima-Cho (JP); Atsushi Umehara, Akashi-shi (JP); Tomoharu Inoue, Kobe-shi (JP); Masaharu Uchikura, Akashi-shi (JP); Masaki Nakagoshi, Akashi-shi (JP)

(73) Assignee: NORITZ CORPORATION, HYOGO (JP)

(21) Appl. No.: 16/192,714

(22) Filed: Nov. 15, 2018

(30) Foreign Application Priority Data
Nov. 24, 2017 (JP) 2017-225657

(51) Int. Cl. F24D 19/10; F24D 17/00; H04W 84/02

(52) U.S. Cl. CPC F24D 19/1051; H04W 84/02; F24D 17/00

(57) ABSTRACT

Provided are a hot water using system and a relay device used therein. The hot water using system includes: a hot water server that is one example of hot water using equipment; a relay device that communicates with the hot water server and communicates with a management server via a communication network, the relay device having a communication setting switch (operation switches) that is placed outdoor and is operated when communication setting for communicating with the communication network is performed; and a switching part that is provided separately from the relay device and switches an operation through the communication setting switch between activation and inactivation.

### CROSS-REFERENCE TO RELATED APPLICATION

This application claims the priority benefit of Japan Patent Application No. 2017-225657, filed on Nov. 24, 2017. The entirety of the above-mentioned patent application is hereby incorporated by reference herein and made a part of this specification.

### BACKGROUND

### Technical Field

The present disclosure relates to a hot water using system that has hot water using equipment such as a hot water server and a relay device used therein.

### Description of Related Art

In the related art, a remote management system that manages home equipment devices using a server connected to a communication network such as the Internet is known. For example, Patent Document 1 (Japanese Laid-Open No. 2016-116159) discloses a configuration capable of controlling electronic devices in a home via a server in a remote fashion and capable of checking running states of the electronic devices by operating a communication terminal such as a smartphone.

Incidentally, in a conventional remote management system for hot water using equipment such as a hot water server, a relay device that is connected to the hot water using equipment with a communication line, for example, is connected to a router, which is connected to the communication network, through wired or wireless communication. In addition, the hot water using equipment and a management server can bidirectionally transmit information therebetween by the relay device being communicatively connected to the management server that is connected to the communication network. For example, various kinds of information regarding the hot water using equipment may be transmitted to the management server via the relay device, the router, and the communication network. Also, it is also possible to operate the hot water using equipment in a remote fashion via the management server and check the state of the hot water using equipment by using a communication terminal such as a smartphone.

In the aforementioned remote management system for the hot water using equipment, the relay device may be placed outdoors in some cases. In such cases, there is a concern that the relay device may be improperly operated by a third person. The relay device is provided with various operation switches. For example, an operation switch (WPS switch) for performing communication setting for communication with a router (wireless LAN router) by a WPS function and an operation switch (AP switch) that causes the relay device to operate as a wireless LAN access point may be provided. In a case in which such a WPS switch or an AP switch is improperly operated by a third person, there is a concern that defects occur in operations of the relay device, and for example, the communication setting of the relay device for communication with the router may be changed.

### SUMMARY

A hot water using system according to an aspect of the present disclosure includes: hot water using equipment; a relay device that communicates with the hot water using equipment and communicates with a management server via a communication network, the relay device having a communication setting switch that is placed outdoor and is operated when communication setting for communicating with the communication network is performed; and a switching part that is provided separately from the relay device and switches an operation through the communication setting switch between activation and inactivation.

Also, a relay device according to an aspect of the present disclosure is a relay device that is used in the aforementioned hot water using system.

### BRIEF DESCRIPTION OF THE DRAWINGS

FIG. 1 is an outline configuration diagram of a remote management system including a hot water using system according to an exemplary embodiment of the present disclosure.

FIG. 2(A) is a diagram illustrating an example of a top screen that is ordinarily displayed on a display part of a remote controller for a hot water server.

FIG. 2(B) is a diagram illustrating an example of an operation effect switching screen that is displayed on the display part of the remote controller for the hot water server.

### DESCRIPTION OF THE EMBODIMENTS

The present disclosure provides a hot water using system capable of preventing defects from occurring in operations of the relay device due to an improper operation of a third person and a relay device used therein.

With the aforementioned configuration, a change in communication setting for communication with the communication network and the like are not performed, and it is possible to prevent defects from occurring in operations of the relay device even if the communication setting switch is improperly operated by a third person, by a user, for example, operating the switching part to inactivate operations through the communication setting switch.

The switching part may be placed indoors. By the switching part being placed indoors in this manner, it is possible to prevent a third person from operating the switching part as far as possible.

The hot water using system may further include a remote controller that is for operating the hot water using equipment in a remote fashion, and the switching part may be provided in the remote controller. With this configuration, it is not necessary to provide the switching part as a separate member from the remote controller.

The hot water using system may further include a notification part that notifies a user of a fact that an improper operation has been performed in a case in which the communication setting switch has been operated when operations through the communication setting switch are inactivated by the switching part.

With this configuration, since the user is notified of the fact that an improper operation has been performed by the notification part, it is possible to promptly address the improper operation when a third person performs an improper operation.

Communication setting of the relay device for communicating with the communication network may be communication setting for communicating with a wireless LAN router connected to the communication network.

The present disclosure has the configuration described above and has an effect that it is possible to provide a hot water using system capable of preventing defects from occurring in operation of the relay device due to an improper operation of a third person and a relay device used therein.

Hereinafter, embodiments will be described with reference to drawings. In addition, the present disclosure is not limited to the following embodiments.

### Embodiment

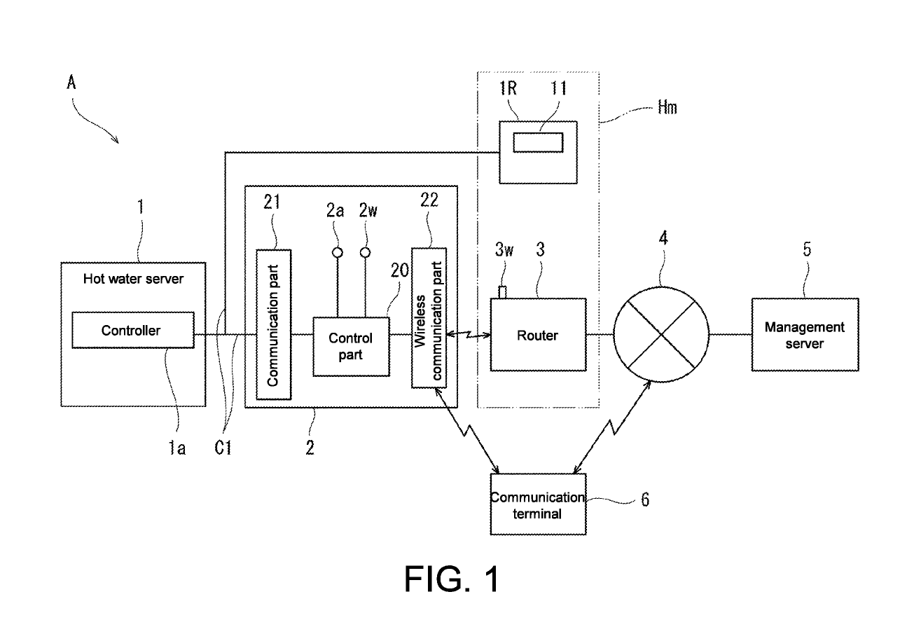

FIG. 1 is an outline configuration diagram of a remote management system including a hot water using system according to an exemplary embodiment of the present disclosure. The remote management system includes a hot water server 1 that is an example of the hot water using equipment, a remote controller 1R for the hot water server 1, a relay device 2 dedicated for the hot water sever, which is communicatively connected to a controller 1a incorporated in the hot water server 1, a management server 5 that is formed of a computer connected to a communication network 4 such as the Internet, and a communication terminal 6 that is formed of a smartphone or the like that a user owns. The management server 5 performs communication with the relay device 2 via the communication network 4 and a router 3 connected to the communication network 4. The router 3 is owned by a resident (user) of a home Hm in which a hot water using system A including the hot water server 1 is placed, and the router 3 is a wireless LAN router in this case.

A configuration of the hot water using system A includes the hot water server 1, the remote controller 1R for operating the hot water server 1 in a remote fashion, and the relay device 2 dedicated for the hot water server.

The hot water server 1 is placed at a predetermined location outside the home Hm, for example, and includes a hot water supply function of serving hot water to a kitchen, a bath tab, and the like. The hot water server 1 is a hot water server of a combustion heating type, for example, and a heat exchanger, a combustion device that heats the heat exchanger using gas or kerosene as fuel, a pipe that is connected to the heat exchanger and the like and serves as a flow path of hot water, a fuel pipe, various sensors, the controller 1a, and the like are accommodated in a case body in the configuration thereof.

The controller 1a is formed of a microcontroller or the like that has a CPU and a memory (a RAM, a ROM, and the like), for example, and controls overall operations of the hot water server 1. In addition, the controller 1a is connected to the remote controller 1R and the relay device 2 via a two-core cable C1 that serves as a communication line and enables bidirectional communication with both the remote controller 1R and the relay device 2.

The remote controller 1R is placed at a predetermined location inside the home Hm, is connected to the controller 1a of the hot water server 1 and the relay device 2 via the two-core cables C1, and enables bidirectional communication with both the controller 1a and the relay device 2. The remote controller 1R is provided with a display part 11 that has an operation part (not illustrated), a liquid crystal screen, and the like. A control signal in accordance with an operation of an operation part is transmitted to the controller 1a of the hot water server 1 by the user operating the operation part of the remote controller 1R, and the user can perform various kinds of setting, such as setting of an operation mode and a hot water temperature of the hot water server 1. In addition, information indicating an operation state and the like of the hot water server 1 is input from the controller 1a of the hot water server 1 and is displayed on the display part 11. Also, the set hot water temperature and the like are also displayed on the display part 11. In addition, a speaker for outputting a buzzer sound, speech, or the like may be incorporated in the remote controller 1R.

The relay device 2 can perform bidirectional communication with both the controller 1a of the hot water server 1 and the remote controller 1R via the two-core cable C1 as described above. Also, the relay device 2 can perform wireless communication with the router 3 through a wireless LAN. For example, the relay device 2 may transmit device information, which has been transmitted from the controller 1a of the hot water server 1, to the management server 5 via the router 3 and the communication network 4 after transforming the communication format thereof. Also, the relay device 2 transmits information, which has been transmitted from the management server 5 via the communication network 4 and the router 3, to the controller 1a of the hot water server 1 after transforming the communication format thereof.

Here, the device information transmitted from the controller 1a of the hot water server 1 to the management server 5 includes device configuration information indicating a type or the like of the hot water server 1, which is transmitted for the first time in the communication with the controller la and the relay device 2, operating state information indicating an operating state of the hot water server 1, which is transmitted periodically (at an interval of 1 hour, for example), error information indicating abnormality of the hot water server 1, and the like. The operating state information is information including a set hot water temperature, a combustion operating frequency, a combustion operating time, and the like of the hot water server 1.

The management server 5 includes a first storage part that stores device information that is transmitted from the controller 1a of the hot water server 1 via the relay device 2. The device information is transmitted from the relay device 2 to the management server 5 along with a serial number of the relay device 2. Also, the management server 5 stores the received device information in the first storage part in association with the serial number of the relay device 2.

In addition, the management server 5 includes a second storage part that stores association information. The association information is information regarding association with the serial number of the relay device 2 and a user account transmitted from the communication terminal 6 of the user, for example.

Note that the management server 5 may be formed of a plurality of computers that are connected to the communication network 4. That is, the management server 5 may be formed of a plurality of servers that are assigned to and execute functions thereof.

The communication terminal 6 is a mobile terminal, such as a smartphone, which the user owns, and can be connected to the communication network 4 via a base station or the like of a 3G (Third Generation) or 4G (Fourth Generation) mobile phone network. An application program (hereinafter, referred to as a “system-specific application”) dedicated to the hot water using system has been installed on the communication terminal 6, and the user can operate the communication terminal 6, activate the system-specific application, and perform remote operations, state checking, and the like of the hot water server 1 via the management server 5 or the like.

Next, the relay device 2 will be described in more detail. The relay device 2 includes, for example, a control part 20, a communication part 21, a wireless communication part 22, an operation switch (WPS switch) 2w for performing communication setting for communication with a router (wireless LAN router) using a Wi-Fi Protected Setup (WPS) function, an operation switch (AP switch) 2a that causes the relay device 2 to operate as a wireless LAN access point, and the like. These are accommodated in a case body of the relay device 2, and the operation switches such as the WPS switch 2w and the AP switch 2a can be operated by opening a cover of the case body.

The control part 20 can be formed of a micro controller or the like that includes a CPU and a memory. The control part 20 controls overall operations of the relay device 2 by the CPU reading and executing software for control that is stored in the memory.

The communication part 21 performs communication processing for communication with both the controller 1a of the hot water server 1 and the remote controller 1R via the two-core cable C1. In addition, the wireless communication part 22 communicates with the management server 5 via the router 3 and the communication network 4. At this time, the wireless communication part 22 performs communication processing for wireless communication based on standards of a wireless LAN with the router 3.

The control part 20 causes the wireless communication part 22 to transmit information to be transmitted to the management server 5 in the information that has been transmitted from the controller 1a of the hot water server 1 and has been received by the communication part 21. In addition, the control part 20 causes the communication part 21 to transmit information to be transmitted to the controller 1a and/or the remote controller 1R in the information that has been transmitted from the management server 5 and has been received by the wireless communication part 22.

The WPS switch 2w and the AP switch 2a are communication setting switches that are operated when communication setting of the relay device 2 with the router 3 is performed. If the user performs an operation of pressing the WPS switch 2w, for example, an operation signal in response to the operation is input to the control part 20. If the user performs an operation of pressing the AP switch 2a, an operation signal in response to the operation is input to the control part 20, and the control part 20 performs processing in accordance with the operation signal.

The user can automatically perform communication setting by pressing the WPS switch 2w of the relay device 2 and the WPS switch 3w of the router 3, for example, when the communication setting through the wireless LAN of the relay device 2 with the router 3 is performed.

In addition, the user can perform communication setting through the wireless LAN between the relay device 2 and the router 3 by operating the AP switch 2a. The AP switch 2a is a switch for turning functions of the wireless LAN access point on and off If the AP switch 2a is pressed by the user, the control part 20 causes the wireless communication part 22 to function as a wireless LAN access point. Next, the user operates the communication terminal 6 and connects the communication terminal 6 to the relay device 2. Specifically, the user selects the relay device 2 in a list of access points displayed on the screen of the display part of the communication terminal 6 and inputs an encrypted key.

As described above, the user operates the communication terminal 6 and causes the display part of the communication terminal 6 to display a communication setting screen for a wireless LAN after connecting the communication terminal 6 to the relay device 2. If an SSID of the router 3 and the encrypted key are input on this communication setting screen, the SSID of the router 3 and the encrypted key are transmitted to the wireless communication part 22. This enables communication setting for the wireless LAN between the relay device 2 and the router 3.

In addition, if the AP switch 2a is pressed by the user, the relay device 2 (the wireless communication part 22) functions as a wireless LAN access point, and the communication terminal 6 is connected to the relay device 2, the communication terminal 6 acquires and stores the serial number of the relay device 2 using the system-specific application. Thereafter, the system-specific application of the communication terminal 6 is started again, a user management site that the management server 5 provides is logged in, and the serial number of the relay device 2 is transmitted to the management server 5. The management server 5 associates the user account transmitted from the communication terminal 6 at the time of the log-in with the serial number of the relay device 2 and stores the information as association information in the second storage part. After the association information is stored in the management server 5 in this manner, the user can operate the communication terminal 6, log into the user management site that the management server 5 provides, perform a remote operation of the hot water server 1 and check a state of the hot water server 1 connected to the relay device 2 with the serial number associated with the user account at the time of the log-in.

In a case in which the relay device 2 is placed outdoor, for example, there is a concern that the WPS switch 2w and the AP switch 2a that are used for communication setting for communication with the router 3 are improperly operated by a third person with harmful intent.

Thus, an operation effect switching part (switching part) with which an operation for switching operations of the WPS switch 2w and the AP switch 2a between activation and inactivation is provided in the embodiment. The operation effect switching part is provided as a separate member from the relay device 2 and is provided in the remote controller 1R, for example.

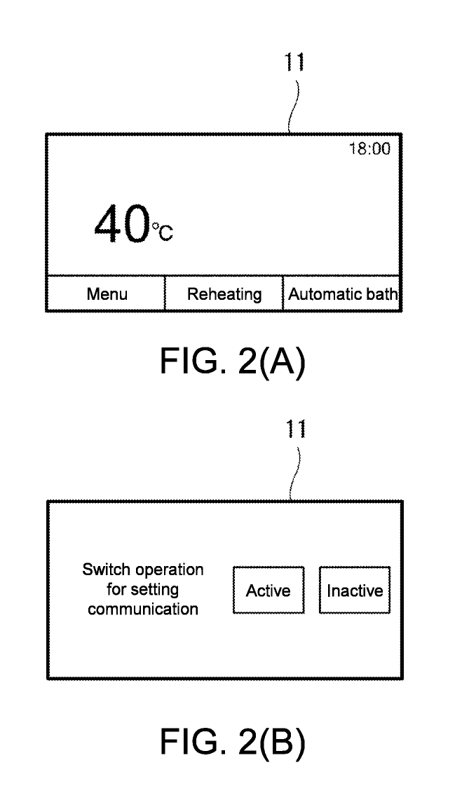

FIG. 2(A) is a diagram illustrating an example of a top screen that is ordinarily displayed on the display part 11 of the remote controller 1R when the hot water server 1 is running, and FIG. 2(B) is a diagram illustrating an example of an operation effect switching screen (hereinafter, also referred to as a “switching screen”) that is used for switching operations of the communication setting switch (the WPS switch 2w and the AP switch 2a) between activation and inactivation.

Here, the display part 11 of the remote controller 1R includes a touch panel, and the switching screen illustrated in FIG. 2(B) can be called from a menu screen that is caused to display by performing a touch operation on a “MENU” on the top screen illustrated in FIG. 2(A), for example.

When the switching screen illustrated in FIG. 2(B) is called, a state set at that timing is displayed in a blinking manner, for example. In a case in which “ACTIVE” is displayed in a blinking manner on the screen, for example, operations through the communication setting switch are in an active state. In a case in which “INACTIVE” is displayed in a blinking manner, operations through the communication setting switch are in an inactive state. If a touch operation is performed on “INACTIVE” in the case in which “ACTIVE” is displayed in a blinking manner, for example, “ACTIVE” becomes ordinary display, “INACTIVE” is switched to blinking display, and operation inactivation information is transmitted from the remote controller 1R to the communication part 21 of the relay device 2. Meanwhile, if a touch operation is performed on “ACTIVE” in the case in which “INACTIVE” is displayed in a blinking manner, “INACTIVE” becomes ordinary display, “ACTIVE” is switched to blinking display, and operation activation information is transmitted from the remote controller 1R to the communication part 21 of the relay device 2.

The control part 20 of the relay device 2 includes a storage region (first storage region) that mutually exclusively stores the operation inactivation information and the operation activation information. If the operation inactivation information is input to the communication part 21 when the operation activation information is stored in the first storage region, the operation activation information is rewritten with the operation inactivation information. Meanwhile, if the operation activation information is input to the communication part 21 when the operation inactivation information is stored in the first storage region, the operation inactivation information is rewritten with the operation activation information.

Note that when the switching screen illustrated in FIG. 2(B) is called, the remote controller 1R is configured to acquire the operation activation information or the operation inactivation information stored in the first storage region from the relay device 2 and display “ACTIVE” or “INACTIVE” in a blinking manner on the basis of the acquired information.

Here, the remote controller 1R may also include a storage region that is similar to the first storage region of the relay device 2 and may display “ACTIVE” or “INACTIVE” in a blinking manner on the switching screen illustrated in FIG. 2(B) on the basis of the operation activation information or the operation inactivation information stored in the storage region.

Note that various modifications can be added to the method of displaying whether or not the operations through the communication setting switch are in the active state or the inactive state on the switching screen illustrated in FIG. 2(B) and the method is not limited to the aforementioned example. In addition, various modifications can also be added to the operation method for switching the state, and the method is not limited to the aforementioned example.

In addition, if the WPS switch 2w or the AP switch 2a is operated, and an operation signal is input when the operation activation information is stored in the first storage region, the control part 20 of the relay device 2 regards the operation signal as an effective signal and performs processing in accordance with the operation signal. Meanwhile, if the WPS switch 2w or the AP switch 2a is operated, and an operation signal is input when the operation inactivation information is stored in the first storage region, the control part 20 regards the operation signal as an inactive signal (in other words, regards the operation signal as having not been input) and does not perform the processing in accordance with the operation signal.

Further, the control part 20 functions as an improper operation determination part and determines that an improper operation has been performed when operations through the communication setting switch are in the inactive state, that is, the operation inactivation information is stored in the first storage region, at least one of the WPS switch 2w and the AP switch 2a is operated, and an operation signal is input through the operation. In addition, the control part 20 is configured such that if it is determined that the improper operation has been performed, the control part 20 transmits information (improper operation information) indicating that the improper operation has been performed from the communication part 21 to the remote controller 1R.

If the improper operation information is received, the remote controller 1R notifies the user of the fact that the improper operation has been performed. As a notification method, the fact that the improper operation has been performed may be displayed on the screen of the display part 11 or may be output as voice from a built-in speaker, for example. In this case, the remote controller 1R functions as the notification part that notifies the user of the improper operation information.

In addition, the control part 20 may transmit the improper operation information from the wireless communication part 22 to the management server 5 via the router 3 and the communication network 4. If the improper operation information is received, then the management server 5 may transmit the improper operation information as an e-mail, for example, to the communication terminal 6 corresponding to the relay device 2 on the basis of the association information stored in the second storage part or may transmit the improper operation information using the system-specific application instead of an e-mail. In this case, the communication terminal 6 functions as the notification part that notifies the user of the improper operation information.

In the embodiment, a change or the like in communication setting of the relay device 2 with the router 3 is not performed, and it is possible to prevent defects from occurring in operations of the relay device 2 even if a third person improperly operates the communication setting switch, by the user inactivating operations through the communication setting switch (the WPS switch 2w and the AP switch 2a) by operating the remote controller 1R after performing the communication setting of the relay device 2 for communication with the router 3. In addition, it is possible to prevent, by inactivating operations through the AP switch 2a, the third person from operating the AP switch 2a, stealing the serial number of the relay device 2 by using a communication terminal of the third person, rewriting the association information stored in the management server 5, and operating the hot water server 1 in a remote fashion by using the communication terminal of the third person in a case in which operations through the AP switch 2a are active. The aforementioned effect can also be achieved in a case in which the relay device 2 is placed outdoor where the third person can easily enter.

In addition, since the user is notified of the fact that an improper operation has been performed by the remote controller 1R and the communication terminal 6 of the user when the improper operation of the communication setting switch has been performed, it is possible to promptly address the improper operation of the third person. Note that since the user is similarly notified even in a case in which the user operates the communication setting switch without knowing that operations through the communication setting switch are inactivated, the user can ascertain that the operations have been inactivated, switch and activate the operations, and then perform operations in such a case.

Also, although it is not necessary to form the operation effect switching part and the notification part as separate members from the remote controller 1R by providing the operation effect switching part and the notification part in the remote controller 1R in the embodiment, it is also possible to separate the operation effect switching part and the notification part as separate members from the remote controller 1R and to provide the operation effect switching part and the notification part indoors. It is possible to prevent the operation of switching the operation effect switching part from being performed by a third person, by providing the operation effect switching part indoors.

In addition, the embodiment may be configured such that the user operates the communication terminal 6 to execute the functions of the operation effect switching part. In this case, the operation activation information or the operation inactivation information is transmitted to the management server 5 by the user operating the communication terminal 6, logging into the user management site that the management server 5 provides, and performing a predetermined operation. Then, the management server 5 refers to the association information including the user account that has been acquired at the time of log-in and transmits the operation activation information or the operation inactivation information to the relay device 2 that has the serial number included in the association information. The relay device 2 stores the received operation activation information or operation inactivation information in the first storage region in the control part 20. The configuration described above may be employed.

In addition, although the control part 20 of the relay device 2 is adapted to function as the improper operation determination part in the embodiment, the present disclosure is not limited thereto. It is also possible to employ a configuration in which the functions of the improper operation determination part are provided in the controller 1a, the remote controller 1R, or the management server 5. In addition, it is also possible to employ a configuration in which the first storage region that mutually exclusively stores the operation activation information and the operation inactivation information is also provided in the controller 1a, the remote controller 1R, or the management server 5.

Note that in a case in which a wireless relay (wireless LAN relay) is provided in the home Hm of the user, the relay device 2 and the router (wireless LAN router) 3 may be configured to be communicatively connected to each other via the wireless relay.

In addition, the connection of the relay device 2 with the router 3 is not limited to the wireless connection, and the relay device 2 may be configured to be connected thereto with a LAN cable. If the relay device in this case is referred to as a relay device 2A, the relay device 2A is also provided with the AP switch 2a that is similar to that described above. If the AP switch 2a is pressed, then the relay device 2A can function as a wireless LAN access point and connect the communication terminal 6 to the relay device 2A. Then, it is possible to perform communication setting (setting can also be changed) for a wired LAN with the router 3 on the relay device 2A by further operating the communication terminal 6 in a state in which the communication terminal 6 is connected to the relay device 2A, according to the configuration. Also, the serial number of the relay device 2A is acquired when the communication terminal 6 is connected to the relay device 2A, the user management site that the management server 5 provides is then logged in by using the communication terminal 6, the serial number of the relay device 2 is transmitted to the management server 5, and the association information is thus stored in the second storage part of the management server 5.

In addition, the hot water server 1 that is an example of the hot water using equipment is not limited to one of a combustion heating type in the aforementioned embodiment. For example, the hot water server 1 may be a type that generates heat using a heat pump, a type that generates heat by using heat discharged from a fuel cell or a gas engine, or the like. In addition, the hot water server 1 may have not only the hot water supply function but also other functions. For example, the hot water server 1 may be connected to a bath tab and have a hot water filling function of filling the bath tab with hot water or a reheating function of reheating the hot water in the tab. Also, the hot water server 1 may have a hot water heating function of causing hot water to be circulated between the hot water server 1 and a hot water-type heating terminal by being connected to the hot water-type heating terminal. Also, the hot water using equipment is not limited to the hot water server and may be a filter device or the like, in which a circulating flow path is provided between the hot water using equipment and a bath tab, which filters hot water in the bath tab flowing through the circulating flow path.

On the basis of the above description, multiple improvements and other embodiments of the present disclosure are obvious to those skilled in the art. Therefore, the above description has to be interpreted only as illustrative examples and has been provided for the purpose of teaching best modes for executing the present disclosure to those skilled in the art. Details of the structures and/or the functions of the present disclosure can be substantially changed without departing from the spirit thereof

The present disclosure is effective as a hot water using system capable of preventing defects from occurring in operations of a relay device due to an improper operation of a third person and as a relay device or the like used therein.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A hot water using system comprising:
hot water using equipment;
a relay device that communicates with the hot water using equipment and communicates with a management server via a communication network, the relay device having a communication setting switch that is placed outdoor and is operated when communication setting for communicating with the communication network is performed; and
a switching part that is provided separately from the relay device and switches an operation through the communication setting switch between activation and inactivation.

2. The hot water using system according to claim 1, wherein the switching part is placed indoor.

3. The hot water using system according to claim 1, further comprising:
a remote controller that is for operating the hot water using equipment in a remote fashion,
wherein the switching part is provided in the remote controller.

4. The hot water using system according to claim 2, further comprising:
a remote controller that is for operating the hot water using equipment in a remote fashion, wherein the switching part is provided in the remote controller.

5. The hot water using system according to claim 1, further comprising:
a notification part that notifies a user of a fact that an improper operation has been performed in a case in which an operation has been performed on the communication setting switch when the operation through the communication setting switch are inactivated by the switching part.

6. The hot water using system according to claim 2, further comprising:
a notification part that notifies a user of a fact that an improper operation has been performed in a case in which an operation has been performed on the communication setting switch when the operation through the communication setting switch are inactivated by the switching part.

7. The hot water using system according to claim 3, further comprising:
a notification part that notifies a user of a fact that an improper operation has been performed in a case in which an operation has been performed on the communication setting switch when the operation through the communication setting switch are inactivated by the switching part.

8. The hot water using system according to claim 4, further comprising:
a notification part that notifies a user of a fact that an improper operation has been performed in a case in which an operation has been performed on the communication setting switch when the operation through the communication setting switch are inactivated by the switching part.

9. The hot water using system according to claim 1, wherein communication setting of the relay device for communicating with the communication network is communication setting for communicating with a wireless LAN router connected to the communication network.

10. The hot water using system according to claim 2, wherein communication setting of the relay device for communicating with the communication network is communication setting for communicating with a wireless LAN router connected to the communication network.

11. The hot water using system according to claim 3, wherein communication setting of the relay device for communicating with the communication network is communication setting for communicating with a wireless LAN router connected to the communication network.

12. The hot water using system according to claim 4, wherein communication setting of the relay device for communicating with the communication network is communication setting for communicating with a wireless LAN router connected to the communication network.

13. The hot water using system according to claim 5, wherein communication setting of the relay device for communicating with the communication network is communication setting for communicating with a wireless LAN router connected to the communication network.

14. The hot water using system according to claim 6, wherein communication setting of the relay device for communicating with the communication network is communication setting for communicating with a wireless LAN router connected to the communication network.

15. The hot water using system according to claim 7, wherein communication setting of the relay device for communicating with the communication network is communication setting for communicating with a wireless LAN router connected to the communication network.

16. The hot water using system according to claim 8, wherein communication setting of the relay device for communicating with the communication network is communication setting for communicating with a wireless LAN router connected to the communication network.

17. A relay device that is used in the hot water using system according to claim 1.

18. A relay device that is used in the hot water using system according to claim 2.

19. A relay device that is used in the hot water using system according to claim 3.

20. A relay device that is used in the hot water using system according to claim 4.
